(19) United States
(12) Patent Application Publication
(10) Pub. No.: US 2025/0001329 A1
(43) Pub. Date: Jan. 2, 2025

(54) FILTER SYSTEM WITH FLANGED FILTER CARTRIDGE

(71) Applicant: Cummins Filtration Inc., Nashville, TN (US)

(72) Inventors: Robert A. Bannister, Ames, IA (US); Joshua Luther Young, Livingston, TN (US); Zemin Jiang, Cookeville, TN (US); Aaron M. Wells, Cookeville, TN (US); Ismail C. Bagci, Cookeville, TN (US); Mark J. Johnson, Cookeville, TN (US)

(73) Assignee: Cummins Filtration Inc., Nashville, TN (US)

(21) Appl. No.: 18/216,791

(22) Filed: Jun. 30, 2023

(51) Int. Cl. B01D 27/08; B01D 29/56; B01D 35/00

(52) U.S. Cl. CPC B01D 27/08; B01D 29/56; B01D 35/005; B01D 2201/287; B01D 2201/295; B01D 2201/316; B01D 2201/347; B01D 2201/4061; B01D 2201/4092

(57) ABSTRACT

Various embodiments of two-stage filter assemblies are provided. A filter element of the filter assembly includes a first endplate that is configured to facilitate assembly of the filter element into a filter housing assembly. The first endplate includes a flange that extends radially away from a media pack of the filter and into the channel formed between a lid and a housing of a filter housing assembly. A second endplate of the filter element is coupled to a media pack second end of the media pack. The filter element also includes a first seal member that is coupled to the second endplate. The first endplate and the filter housing assembly are structured to ensure that the filter element is sealingly engaged with the housing when (i) the flange is engaged with the lid and (ii) the lid is fully installed onto the housing.

### TECHNICAL FIELD

The present disclosure relates generally to filters for use with internal combustion engine systems.

### BACKGROUND

Internal combustion engine systems require fuel (e.g., diesel fuel, gasoline, etc.) to operate. The fuel may be contaminated with water and/or particulate matter, which may damage various parts of the engine system if not removed from the fluid. To remove water and other contaminants, the fuel is generally passed through a filter assembly, which may include a particulate filter and/or fuel-water separator.

### SUMMARY

One embodiment of the present disclosure relates to a filter assembly including a filter element and a filter housing assembly. The filter housing assembly includes a housing defining an inner cavity, and a lid engageable with the housing at an opening of the inner cavity. An end of the lid is spaced apart from the housing to form a channel therebetween when the lid is fully installed onto the housing. The filter element is disposed within the inner cavity and includes a media pack, a first endplate, a second endplate, and a seal member. The media pack has a media pack first end and a media pack second end opposite the media pack first end. The first endplate is sealingly engaged with the media pack first end and includes a flange extending radially away from the media pack and extending into the channel between the lid and the housing. The second endplate is coupled to the media pack second end. The first seal member is coupled to the second endplate and is sealingly engaged with the housing when (i) the flange is engaged with the lid and (ii) the lid is fully installed onto the housing.

Another embodiment of the present disclosure relates to a filter element including a media pack and a first endplate. The media pack has a media pack first end and a media pack second end opposite the media pack first end. The first endplate is sealingly engaged with the media pack first end. The first endplate includes a skirt, a flange, and a protrusion. The skirt extends along a longitudinal axis of the media pack from the media pack first end toward the media pack second end. The flange extends radially away from the skirt proximate to a distal end of the skirt. The protrusion extends radially away from the skirt and is disposed axially between the flange and a proximal end of the skirt. At least one of an inner diameter of the skirt or an outer diameter of the skirt in a first region of the skirt between the protrusion and the flange increases from the protrusion to the flange.

Yet another embodiment of the present disclosure relates to a method of installing a filter element into a filter housing assembly. The method includes (i) placing the filter element in an inner cavity defined by a housing of the filter housing assembly, (ii) coupling a lid of the filter housing assembly to the housing by engaging the lid with the housing, and (iii) engaging an end of the lid with a flange of a first endplate of the filter element to move the filter element axially into the inner cavity and to sealingly engage the filter element with the housing.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a front view of a two-stage filter assembly, according to an embodiment.

FIG. 2 is top view of the filter assembly of FIG. 1.

FIG. 3 is an exploded perspective view of the filter assembly of FIG. 1.

FIG. 4 is a front cross-sectional view of the filter assembly of FIG. 1.

FIG. 5 is a perspective view of a first stage filter element of a two-stage filter assembly, according to an embodiment.

FIG. 6 is a front view of the first stage filter element of FIG. 5.

FIG. 7 is a side view of the first stage filter element of FIG. 5.

FIG. 8 is a top view of the first stage filter element of FIG. 5.

FIG. 9 is a bottom view of the first stage filter element of FIG. 5.

FIG. 10 is a front cross-sectional view of the first stage filter element of FIG. 5.

FIG. 11 is a front cross-sectional view of a lid interface portion of the filter assembly of FIG. 1.

FIG. 12 is a front cross-sectional view of a first filtration stage of the filter assembly of FIG. 1.

FIG. 13 is a front cross-sectional view of the filter assembly of FIG. 1 with a lid of a filter housing assembly removed from a housing of the filter housing assembly.

FIG. 14 is a perspective view of a second stage filter element of a two-stage filter assembly, according to an embodiment.

FIG. 15 is a side view of the second stage filter element of FIG. 14.

FIG. 16 is a front view of the second stage filter element of FIG. 14.

FIG. 17 is a top view of the second stage filter element of FIG. 14.

FIG. 18 is a bottom view of the second stage filter element of FIG. 14.

FIG. 19 is a side cross-sectional view of the second stage filter element of FIG. 14.

FIG. 20 is a flow diagram of a method of installing a filter element into a filter housing assembly, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to fuel filtration systems, e.g., diesel fuel filtration systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Internal combustion engine systems require a clean source of fluids (e.g., fuel, oil, etc.) to power and lubricate the engine. Unfiltered fluids may include dirt, metal particles, and other solid contaminants that can damage engine components (e.g., fuel injectors, cylinder rings, pistons, etc.). In order to protect the engine components, the internal combustion engine systems may include a filtration system, which filters incoming and/or recirculating fluids to remove any solid materials before passing the fluids to the engine. In some instances, the filtration system includes a filter housing assembly and a replaceable filter cartridge, which may be periodically replaced by an operator and/or technician to maintain the differential pressure across the filtration system to within reasonable levels.

The filter cartridge is configured to engage the filter housing assembly to prevent fluid bypass across the filter cartridge during operation. For example, the filter cartridge may include a gasket (such as an O-ring) or another form of sealing member that engages with the housing to prevent fluid bypass between the clean and dirty sides of the filter cartridge. These sealing members, between the filter cartridge and the filter housing assembly, are designed to withstand vibration produced by the engine and/or vehicle while operating over different terrains and to prevent fluid bypass across the filter element.

Referring to the figures generally, fuel filtration systems are shown that include a housing-cartridge interface that is configured to (i) facilitate positioning of the filter cartridge and sealing member(s) of the filter cartridge within the housing during assembly, and (ii) to ensure that any seal members of the filter cartridge remain sealingly engaged with the filter housing assembly after installation.

In at least one embodiment, the filter cartridge includes an endplate having a radially extending flange. A lid of the filter housing assembly engages the flange during assembly of the lid onto a housing of the filter housing assembly. The flange is disposed in a gap or circumferential channel defined between an end of the lid and the housing to retain the flange between the lid and the housing. The channel is sized to accommodate dimensional variation in the height of the filter cartridge while preventing the filter cartridge from becoming dislodged from sealing interfaces between the filter cartridge and the housing during operation. In at least one embodiment, the flange is designed to enable greater side-to-side or radial movement of the filter cartridge when the lid is removed, which can facilitate removal of the filter cartridge when servicing the filter assembly. By interfacing both the housing and the lid during assembly, the endplate structure of the filter element can provide consistent force to retain the filter cartridge in position within the filter housing assembly. Such an arrangement can also reduce the number of seal members between the filter cartridge and the housing or lid to ensure consistent sealing between the filter cartridge and the filter housing assembly.

### II. Example Fuel Filtration System

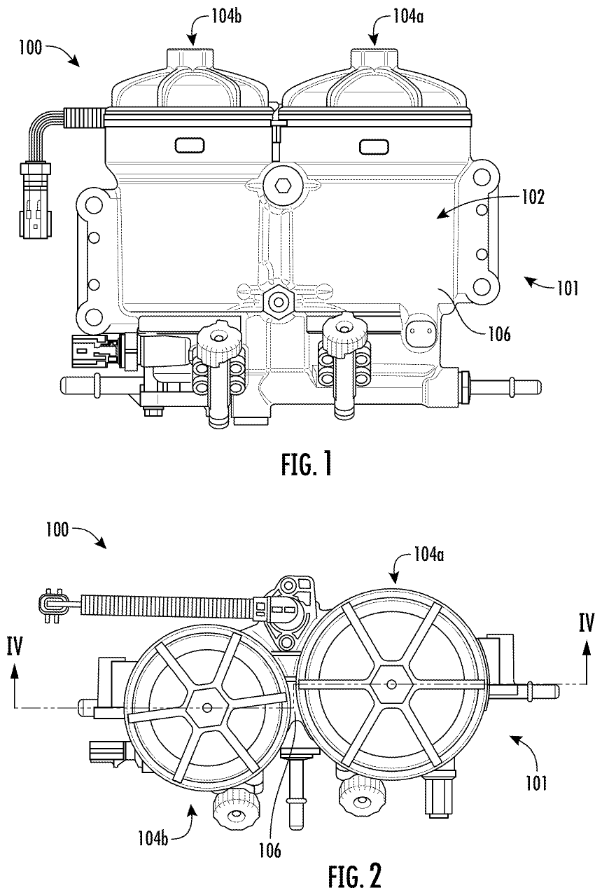

FIGS. 1-4 show a fluid filtration system, shown as filtration system 100, according to an embodiment. The filtration system 100 may be used to filter a fluid provided to an internal combustion engine. The fluid may be a fuel, an engine oil, a hydraulic oil, or another lubricant. In the example embodiment of FIGS. 1-4, the filtration system 100 is a fuel filtration system for a diesel engine that uses diesel fuel to drive the combustion process. The filtration system 100 is configured to be mounted on the diesel engine but may be mounted remotely from the diesel engine in various embodiments.

In at least one embodiment, the filtration system 100 includes a two stage filter assembly 101 that includes a filter housing assembly 102 defining an integrated first filtration stage, shown as first stage 104a, and a second filtration stage, shown as second stage 104b. The second stage 104b is located downstream from the first stage 104a. In some embodiments, the filter housing assembly 102 includes a cross-flow conduit or transfer tube that is integrated into the filter housing assembly 102 and that fluidly couples the first stage 104a (e.g., a clean side of the first stage 104a) and the second stage 104b (e.g., a dirty side of the second stage 104b).

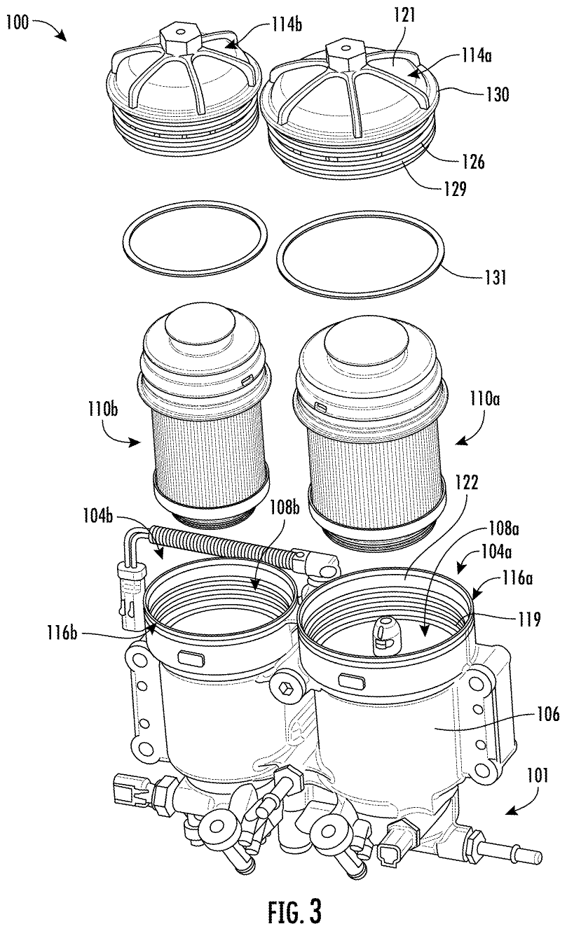

The filter housing assembly 102 includes a housing 106 (e.g., a canister, a housing body, a shell, etc.) defining at least one inner cavity. In the embodiment of FIG. 3, the housing 106 defines a plurality of inner cavities (e.g., filter cavities, etc.) including a first inner cavity 108a configured to receive a first stage filter cartridge 110a therein and a second inner cavity 108b configured to receive a second stage filter cartridge 110b therein. The filter housing assembly 102 also includes a lid for each filtration stage of the filter assembly 101. For example, the filter housing assembly 102 includes a first lid 114a configured to engage the housing 106 at a first cavity opening 116a of the first inner cavity 108a, and a second lid 114b that is configured to engage the housing 106 at a second cavity opening 116b of the second inner cavity 108b.

The filter housing assembly 102 and the lids may be made from the same or different materials. For example, the filter housing assembly 102 may be made (e.g., cast or otherwise formed) from an aluminum material or another strong and lightweight material. The lids may be made (e.g., injection molded or otherwise formed) from a plastic material or another incinerable material.

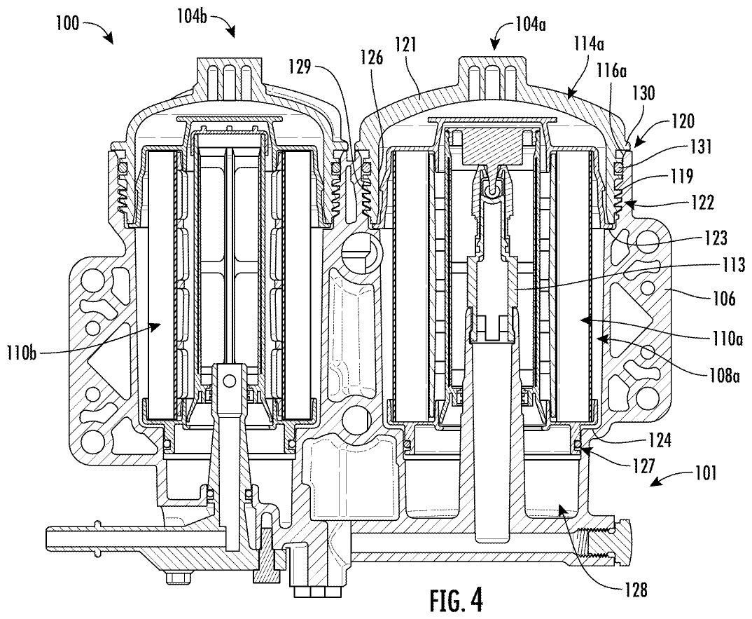

As shown in FIG. 4, the housing 106 defines at least one cylindrical inner cavity, shown as first inner cavity 108a, with a substantially circular cross-section. A first end 120 (e.g., an upper end, an open end, etc.) of the housing 106 defines the first cavity opening 116a to the first inner cavity 108a. The housing 106 includes a first threaded portion 119 extending along a first inner surface 122 of the housing 106, from the first end of the housing 106 into the first inner cavity 108a.

The housing 106 includes a first housing ledge 123 (e.g., shelf, step, etc.) positioned circumferentially about the first end 120 of the housing 106 and extending radially into the first inner cavity 108a from the first inner surface 122. The housing 106 also includes a second housing ledge 124 disposed between the first housing ledge 123 and a closed end of the housing 106. An upper surface of each one of the first housing ledge 123 and the second housing ledge 124 are arranged in a substantially perpendicular relative to the inner sidewall of the housing 106 (e.g., substantially horizontal as shown in FIG. 4).

A second inner surface 127 of the housing 106 extends axially away from the second housing ledge 124, in a substantially perpendicular orientation relative to the second housing ledge 124. In some embodiments, the second inner surface 127 defines a radially-facing sealing surface for the filter cartridge. In at least one embodiment, the second inner surface 127 includes a cylindrical sidewall having a uniform radius along its length in the axial direction (e.g., the second inner surface 127 is not tapered). Such an arrangement can help maintain sealing between the housing 106 and the filter cartridge while also allowing for axial movement of the filter cartridge along the second inner surface 127 during operation, as will be further described.

In some embodiments, the housing 106 defines a tapered or chamfered section along the inner wall of the housing 106 between the second inner surface 127 and the second housing ledge 124, which can facilitate alignment between the first stage filter cartridge 110a and the housing 106 during installation.

The lids are configured to threadably and sealingly engage the housing 106 and to prevent fluid leakage from the filter housing assembly 102. In an embodiment, at least one lid (e.g., the first lid 114a) includes a top cover wall 121 and a cylindrical extension 126 extending axially away from the top cover wall 121. The cylindrical extension 126 includes a second threaded portion 129 along an outer radial surface of the cylindrical extension 126 extending from an end of the cylindrical extension 126 opposite the top cover wall 121. The second threaded portion 129 is configured to threadably engage the first threaded portion 119 of the housing 106.

In the embodiment of FIGS. 3-4, the lid also includes a radial extension 130 (e.g., a circumferential flange, a ring, a tab, etc.) disposed at proximal end of the cylindrical extension 126 between the second threaded portion and the top cover wall 121. The radial extension 130 extends radially away from the cylindrical extension 126 and protrudes radially beyond the second threaded portion 129. The radial extension 130 is configured to engage an end wall of the housing 106 at the first cavity opening 116a of the first inner cavity 108a to prevent over-insertion of the lid onto the housing 106.

In at least one embodiment, the filter assembly 101 also includes a seal member 131 (e.g., an O-ring, a gasket, etc.) disposed on the lid between the second threaded portion 129 and the radial extension 130 to sealingly engage the lid with the housing 106. In the embodiment of FIG. 4, the seal member 131 is a radial seal member that faces radially away from the cylindrical extension 126 and that is configured to sealingly engage an inner radial surface of the housing 106 that defines a respective one of the inner cavities.

The filter housing assembly 102 is configured to direct a flow of fuel through the first stage 104a and the second stage 104b (through the first stage filter cartridge 110a and the second stage filter cartridge 110b). Referring to FIG. 4, flow entering the two stage filter assembly is introduced from an inlet port of the first stage 104a to an annular cavity on the dirty side of the first stage filter cartridge 110a. The flow than passes through the first stage filter cartridge 110a and into standpipe 113 and through a horizontal leg of the cross-flow conduit. The clean fluid from the first stage 104a continues (e.g., via a vertical leg of the cross-flow conduit, or another cross-flow tube geometry) and into a dirty side of the second stage 104b. From there, the fluid passes through the second stage filter cartridge 110b, and through another standpipe to an outlet port and the rest of the filtration system 100.

In some embodiments, the second stage filter cartridge 110b and/or the first stage filter cartridge 110a includes an injection molded center post with an integrated outlet quick-connect port/fitting to ensure an optimum cleanliness level for fuel flowing out of the module. In some embodiments, the standpipe 113 includes a no filter no run (NFNR) ball feature to ensure a filter cartridge is present within the filter assembly 101 and to prevent fuel from being delivered to the engine system when a non-genuine filter element is placed into the filter assembly 101. While the interface designs herein are described with reference to a two stage filter assembly, it should be appreciated that similar designs may be implemented in a single stage filter assembly design that includes a single filter cartridge without departing from the inventive principles disclosed herein.

As shown in FIGS. 4, each of the first stage 104a and the second stage 104b includes an integrated fuel collecting sump 128 (e.g., cavity, etc.) at a closed end of the housing 106 to collect water that has been separated by the first stage filter cartridge 110a or the second stage filter cartridge 110b. In some embodiments, the filtration system 100 also includes at least one integrated water-in-fuel (WIF) sensor to determine when water needs to be drained from the filter housing assembly 102, through a drain valve assembly that fluidly couples an inner cavity of the filter housing assembly 102 to an environment surrounding the two stage filter assembly.

For example, as shown in FIG. 4, any water that coalesces toward the lower end of the first stage filter cartridge 110a or that is separated downstream of the first stage filter cartridge 110a is directed through openings at the lower end (e.g., through a perforated extension between an inner and outer portion of the first stage filter cartridge 110a) to the fuel collecting sump and the drain valve assembly. In at least one embodiment, the drain valve assembly is shared between each of the first stage 104a and the second stage 104b. In other embodiments, each filter stage includes its own separate drain valve assembly.

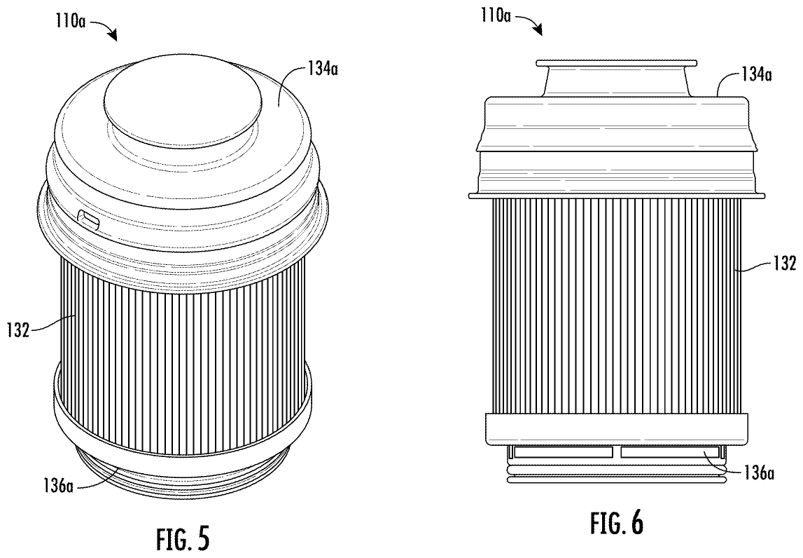

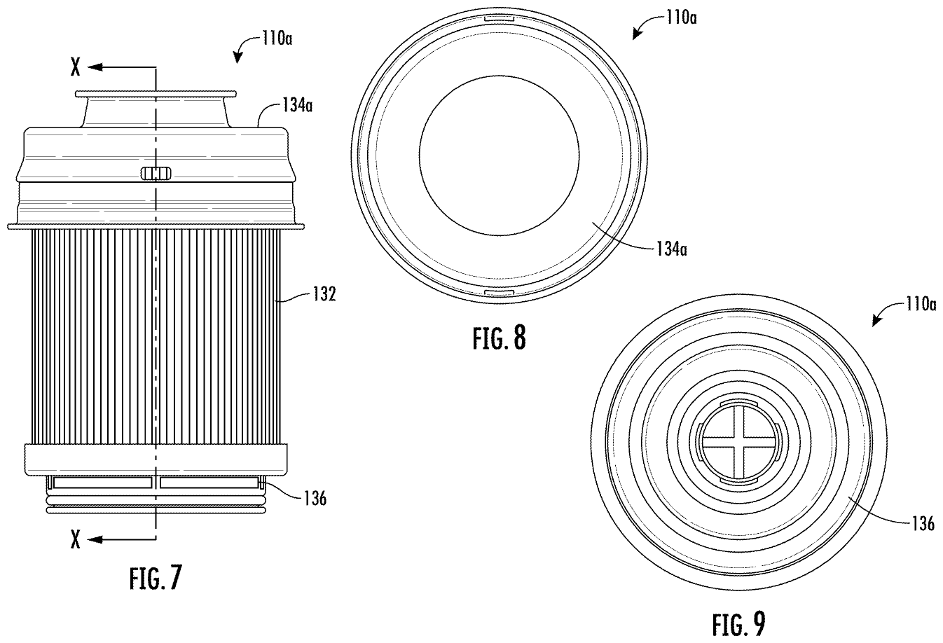

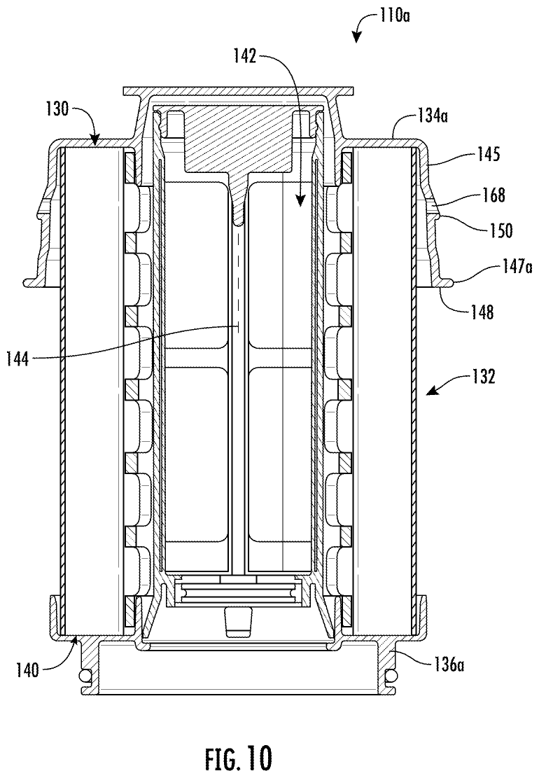

Referring to FIGS. 5-10, a first stage filter cartridge 110a is shown, according to an embodiment. The first stage filter cartridge 110a is a removable filter cartridge that includes features that interface the filter cartridge with the housing 106 and the first lid 114a during installation to simplify the assembly process and to maintain sealing between the filter cartridge and the filter housing assembly 102 during operation.

The first stage filter cartridge 110a (e.g., filter element assembly, etc.) includes a media pack 132, a first endplate 134a, and a second endplate 136a. In some embodiments, the first stage filter cartridge 110a also includes an inner portion (an inner filter media pack, an inner filter element, etc.) disposed within a central cavity defined by the media pack 132. In at least one embodiment, the inner portion (e.g., inner media pack, etc.) includes a hydrophobic screen assembly to improve fuel-water separation performance of the first stage filter cartridge 110a.

Referring to FIG. 10, the media pack 132 includes formed filtration media having a media pack first end 138 (e.g., a first axial end, etc.) and a media pack second end 140 (e.g., a second axial end, etc.) opposite the media pack first end 138. In at least one embodiment, the formed filtration media is arranged as a cylindrical tube that circumscribes a central cavity 142 having a central axis 144, which is co-linear with a central axis of the first stage filter cartridge 110a. The media pack 132 includes filter media structured to filter particulate matter and water from fuel flowing therethrough to produce filtered fluid (e.g., clean fluid). The filter media may include porous material having a predetermined pore size. The filter media may include a paper-based filter media, a fiber-based filter media, or the like. In an embodiment, at least one filter cartridge (e.g., the first stage filter cartridge 110a, the second stage filter cartridge 110b, etc.) is a fuel-water separator containing coalescing media and stripping media to achieve optimal water/particle removal and engine protection. In some embodiments, at least one of the filter cartridges includes an integrated coalescing wrap and hydrophobic screen to enhance water-separation performance of the filter cartridge(s).

The first stage filter cartridge 110a is arranged as an outside-in flow filter cartridge having an outer dirty side and an inner clean side. Fluid to be filtered passes from the dirty side of the first stage filter cartridge 110a to the central cavity 142. In other embodiments, the flow direction through the first stage filter cartridge 110a is reversed.

The first stage filter cartridge 110a also includes endplates on opposing ends of the media pack 132, shown as the first endplate 134a and the second endplate 136a. The first endplate 134a (e.g., the upper endplate) of the first stage filter cartridge 110a is sealingly engaged with a media pack first end 138 (e.g., a first axial end) of the media pack 132, and the second endplate 136a (e.g., the bottom endplate) is sealingly engaged with the media pack second end 140 (e.g., a second axial end) of the media pack 132.

In the embodiment of FIG. 10, the first endplate 134a of the first stage filter cartridge 110a includes a skirt 146 extending radially away from an outer perimeter of the media pack first end 138 and axially (e.g., parallel to the central axis 144 of the media pack 132) from the media pack first end 138 toward the media pack second end 140. A distal end 148 (e.g., a free end, an open end, etc.) of the skirt 146 is disposed at an intermediate position between the media pack first end 138 and the media pack second end 140.

The distal end 148 of skirt 146 is spaced radially apart from an outer perimeter of the media pack 132. The skirt 146 circumferentially surrounds the media pack first end 138 of the media pack 132. The skirt 146 includes a flange 147a extending radially away from the skirt 146 and the media pack 132 at the distal end 148. The flange 147a is a circumferential extension (e.g., a wall, a tab, etc.) that extends along an entire outer perimeter of the skirt 146. In other embodiments, the flange 147a may be formed in multiple sections that extend along portions of the outer perimeter of the skirt 146 at the distal end 148. In some embodiments, the flange 147a is oriented substantially perpendicular to the skirt 146 and the central axis 144.

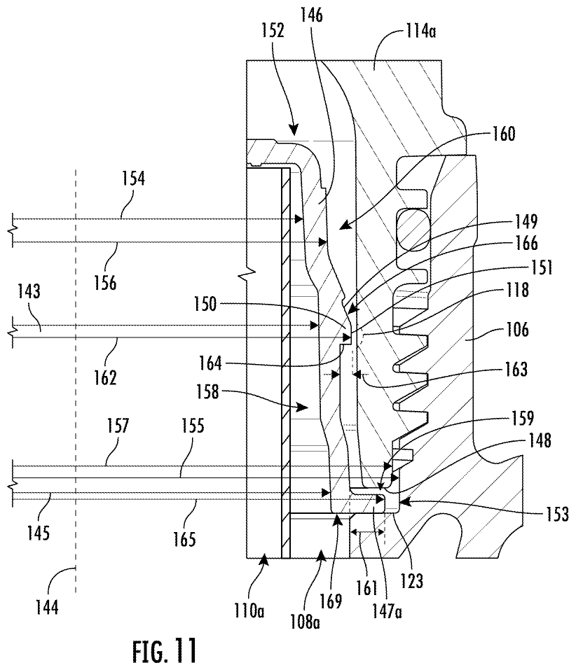

The flange 147a is configured interface with the housing 106 and the first lid 114a to position the first stage filter cartridge 110a within the first inner cavity 108a and to sealingly engage the first stage filter cartridge 110a with the housing 106. Referring to FIG. 11, the distal end 148 of the first lid 114a is spaced apart from the housing 106 to form a channel 153 therebetween when the first lid 114a is fully installed onto the housing 106. As used herein, “fully installed” refers to a position in which the first lid 114a (or other first component) is tightened or otherwise completely fastened and/or secured onto the housing 106 (or other second component).

The first lid 114a and the first housing ledge 123 together define the channel 153. In some embodiments, a first surface (e.g., an upper surface as shown in FIG. 11) of the channel 153 is defined by a surface at the distal end 148 of the first lid 114a. A second surface (e.g., a lower surface as shown in FIG. 11) of the channel 153 is defined by the first housing ledge 123 and extends substantially parallel to the first surface. A third surface (e.g., a side surface, etc.) of the channel 153 is defined by the housing 106 and extends axially from the first surface to the second surface without any intervening ledges or channels therebetween. In the embodiment of FIG. 11, the channel 153 is a substantially rectangular-shaped channel. In other embodiments, the shape of the channel 153 may be different.

An outer diameter 155 of the first housing ledge 123 is greater than an outer diameter 157 of the first lid 114a at the distal end 148 of the first lid 114a. The flange 147a is spaced axially apart the first lid 114a and/or the housing 106 to form an axial gap 159 between (i) the flange 147a and (ii) the first lid 114a and/or the housing 106 when the first lid 114a is fully installed onto the housing 106. Such gaps in both the radial and axial direction between the flange 147a and the surfaces of the channel 153 accommodates dimensional variations in the first endplate 134a, while at the same time ensuring sufficient clearance so that the first lid 114a can be fully installed onto the housing 106 to sealingly engage the housing 106. In at least one embodiment, an axial height of the axial gap 159 is within a range between 0 mm and 1.5 mm (e.g., between 0 mm and 1.25 mm, between 0 mm and 1 mm, etc.), such as approximately 0.5 mm when the flange 147a is centered within the channel 153. In other embodiments, the size of the axial gap 159 is different.

In at least one embodiment, the skirt 146 includes a protrusion 150 that extends radially away from the skirt 146 and the media pack 132. The protrusion 150 is spaced axially apart from the flange 147a. The protrusion 150 is disposed axially between the flange 147a and a skirt proximal end 152 of the skirt 146. In at least one embodiment, the skirt 146 includes the flange 147a only (without a separate protrusion 150).

Referring again to FIG. 10, the protrusion 150 includes a bump-out or other projection that is configured to engage with an inner surface of the first lid 114a to prevent radial movement of the first stage filter cartridge 110a within the housing 106 during operation. In one embodiment, the protrusion 150 includes a continuous ring extending in a circumferential direction around the outer perimeter of the skirt 146 relative to the central axis 144 of the media pack 132. In other embodiments, the protrusion 150 includes a plurality of bump-outs or projections at different circumferential positions along the skirt. An axial position of the protrusion 150 along the skirt 146 may also be different in various embodiments. In one embodiment, the protrusion 150 is disposed proximate to the proximal end of the skirt 146. In other embodiments, the protrusion 150 is disposed proximate to a distal end of the first lid 114a when the first lid 114a is fully installed onto the housing 106.

In at least one embodiment, the protrusion 150 defines a tapered outer radial surface 166 forming a barb shape when viewed along a cross-section along a vertical reference plane that extends parallel to the central axis 144 of the media pack 132. In such an implementation, an outer diameter of the protrusion 150 increases moving along the tapered outer radial surface 166 from a skirt proximal end 152 of the skirt 146 toward a skirt distal end 169 of the skirt 146. In some embodiments, the tapered outer radial surface 166 extends along an entire axial length of the protrusion 150 such that the protrusion 150 has a triangular-shaped cross-section. In other embodiments, as shown in FIG. 11, the tapered outer radial surface 166 extends along only a first portion 149 (e.g., an upper portion as shown in FIG. 11) of the protrusion 150 and transitions to a cylindrical surface of constant radius over a second portion 151 (e.g., a lower portion as shown in FIG. 11) of the protrusion 150. The protrusion 150 defines an endcap ledge 164 at a distal end of the protrusion 150 (at a distal end of the second portion 151) having a step-change in outer diameter. Among other benefits, incorporating a tapered outer radial surface 166 for the protrusion 150 can facilitate assembly by allowing greater coaxial misalignment between the first lid 114a and the first stage filter cartridge 110a during assembly of the first lid 114a onto the housing 106.

Still referring to FIG. 11, the skirt 146 is designed to facilitate positioning of the filter cartridge during installation and to maintain an axial position of the filter cartridge within the housing 106 after installation. In some embodiments, at least one of an inner diameter 154 of the skirt 146 or an outer diameter 156 of the skirt 146 (either one or both the inner diameter 154 and outer diameter 156) in a first region 158 of the skirt 146 between the protrusion 150 and the flange 147a increases from the protrusion 150 to the flange 147a. In the embodiment of FIG. 11, at least one of the inner diameter 154 or the outer diameter 156 of the skirt 146 in a second region 160 of the skirt 146 between the skirt proximal end 152 of the skirt 146 and the protrusion 150 increases from the skirt proximal end 152 to the protrusion 150. In at least one embodiment, an inner diameter 143 of the first endplate 134a at the protrusion 150 is less than an inner diameter 145 of the first endplate 134a at the flange 147a. In some embodiments, an outer diameter of the skirt 146 at the protrusion 150 is approximately equal to an outer diameter of the skirt 146 proximate to the flange 147a.

In at least one embodiment, the protrusion 150 is configured to clip onto or otherwise detachably engage the first lid 114a during assembly. For example, as shown in FIG. 11, the first lid 114a includes a groove 118 extending in a circumferential direction along an inner surface (e.g., a radial facing surface). In some embodiments, the groove 118 is shaped complementary to the protrusion 150 so that the protrusion 150 nestably engages the groove 118 during assembly. In such embodiments, an outer diameter of the protrusion 150 is greater than an inner diameter of first lid 114a away from the groove 118. However, it should be appreciated that the shape of the groove 118 may be different from the protrusion 150 in various embodiments. During servicing, engagement between the groove 118 and the protrusion 150 causes the filter cartridge to remain coupled to the first lid 114a so that the filter cartridge may be pulled away from the housing 106 during removal of the first lid 114a.

An outer diameter 162 of the protrusion 150 is less than the outer diameter 165 of the flange 147a so that the protrusion 150 is insertable within a hollow cavity defined by the first lid 114a. In some embodiments, a radial length 161 of the flange 147a that extends between an outer diameter of the skirt 146 and an outer diameter of the flange 147a is greater than at least two times a radial length 163 of the protrusion 150 that extends between an outer diameter of the skirt 146 and an outer diameter of the protrusion 150. Such an arrangement can provide radial clearance to accommodate dimensional variations in the design of the first endplate 134a and can reduce the risk of damage associated with compressing the first endplate 134a within the housing 106. In other embodiments, the geometry of the protrusion 150 and the flange 147a is different from that shown in FIG. 11.

The design of the skirt 146 described above can increase support of the filter cartridge under radial loading and can further reduce radial movement of the filter cartridge during engine/vehicle operation. Increasing the inner diameter of the skirt can also decrease manufacturing complexity, as the gradual change in the inner diameter can provide a lead-in to facilitate insertion of the media pack 132 into the first endplate 134a during assembly operations. The change in the inner diameter and/or the outer diameter can be a step change in the first region 158 or the second region 160 that occurs over an axial portion of the first region 158 and/or the second region 160. In other embodiments, the change in the inner diameter and/or the outer diameter of the skirt 146 can be continuous along the first region 158 and/or the second region 160.

Referring again to FIG. 10, the first endplate 134a also defines at least one vent opening 168 extending radially through the skirt 146. In at least one embodiment, the vent opening(s) 168 extend radially through the protrusion 150. In the embodiment of FIG. 10, the first endplate 134a defines two vent openings 168 that are disposed on opposing sides of the skirt 146. The two vent openings 168 are rectangular-shaped openings that are coaxially aligned with one another. In other embodiments, the shape and/or number of the vent openings 168 is different. An axial position of the vent openings 168 may also be different in various embodiments. In the embodiment of FIG. 10, the vent openings 168 are disposed axially between the distal end 148 of the skirt 146 and a location at which adhesive (e.g., epoxy, glue, etc.) is located within the first endplate 134a to bond the media pack 132 to the first endplate 134a. Among other benefits, the vent opening(s) 168 allow pressure equalization between opposing sides of the first endplate 134a and thereby reduce the risk of the first stage filter cartridge 110a becoming dislodged from sealing surfaces of the housing 106.

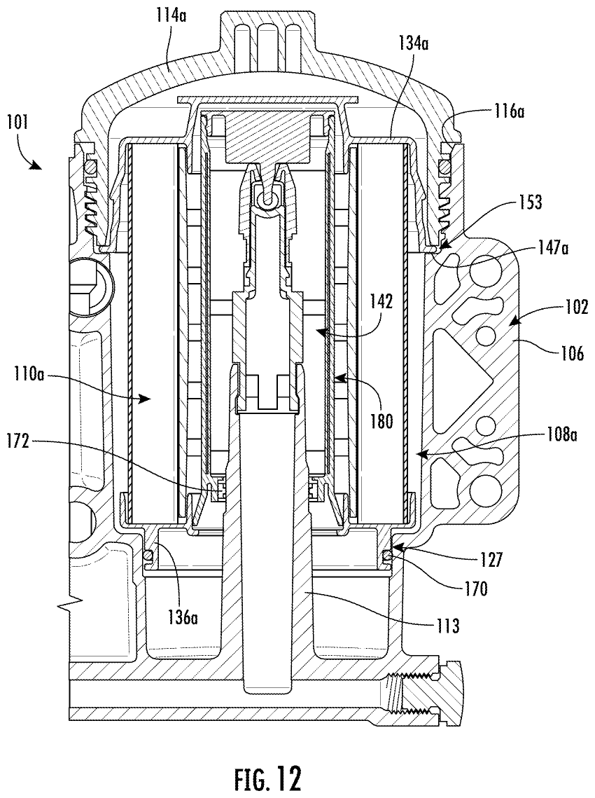

Referring to FIG. 12, the first endplate 134a is configured to interface with the first lid 114a and the housing 106 to sealingly engage the first stage filter cartridge 110a to the housing 106. In some embodiments, the first endplate 134a is configured to engage at least one seal member of the first stage filter cartridge 110a to the housing 106. The interaction between the first endplate 134a and the housing 106 also prevents the sealing member(s) from becoming disconnected from the housing 106 after installation of the first lid 114a to the housing 106.

In at least one embodiment, the second endplate 136a includes a first section sealing member, shown as first seal member 170 (e.g., O-ring, gasket, etc.), that separates the dirty and clean sides of the first stage filter cartridge 110a at a lower end of the housing 106. The first seal member 170 is coupled to the second endplate 136a, to an axially extending sidewall (e.g., cylindrical extension, etc.) that extends axially away from the media pack 132. The first seal member 170 is a radially-facing seal member (e.g., an outer diameter radial seal positioned along an outer perimeter of the second endplate 136a) that forms a radial seal between the second endplate 136a and an interior surface of the housing 106 (proximate a closed end of the first inner cavity 108a opposite the first cavity opening 116a of the housing 106). It should be appreciated that the first seal member 170 could be another form of radial seal member that faces radially inward in some embodiments (e.g., an inner diameter radial seal positioned along an inner perimeter of the second endplate 136a). In some embodiments, the second endplate 136a also includes a pressure bleed port, valve, etc. to prevent damage to the first stage filter cartridge 110a due to high differential pressure (e.g., blockage of the media pack, etc.).

In one embodiment, as described above, the first stage filter cartridge 110a also includes a hydrophobic screen assembly 180. In the embodiment of FIG. 12, the hydrophobic screen assembly 180 is snapped into or otherwise coupled to the filter cartridge 110a. The hydrophobic screen assembly 180 is disposed within the central cavity 142 of the first filter cartridge 110a and extends axially between the first endplate 134a and the second endplate 136a.

In the embodiment of FIG. 12, first stage filter cartridge 110a includes a second seal member 172 (e.g., O-ring, etc.) that is configured to sealingly engage the first stage filter cartridge 110a with the standpipe 113. In some embodiments, the second seal member 172 is part of the hydrophobic screen assembly 180. In the embodiment of FIG. 12, the second seal member 172 is a radially-facing seal member that faces radially away from the media pack and the hydrophobic screen assembly 180. In the embodiment of FIG. 12, the second seal member 172 is disposed proximate to an inner perimeter of the hydrophobic screen assembly 180 and protrudes radially into an interior cavity defined by the hydrophobic screen assembly 180 (e.g., an inner diameter radial seal positioned along an inner perimeter of the hydrophobic screen assembly 180). The second seal member 172 is disposed radially between the inner perimeter of the first stage filter cartridge 110a and the standpipe 113 of the filter assembly 101, and seals radially against an outer surface of the standpipe 113. It should be appreciated that the second seal member 172 could be another form of radial seal member that faces radially outward in some embodiments (e.g., an outer diameter radial seal positioned along an outer perimeter of the hydrophobic screen assembly 180, or another component of the first stage filter cartridge 110a).

In at least one embodiment, the interface between the filter housing assembly 102 and the first endplate 134a is configured so that the first seal member 170 is sealingly engaged with the filter housing assembly 102 (e.g., the housing 106) when (i) the flange 147a is engaged with the first lid 114a, and (ii) the first lid 114a is fully installed onto the housing 106 (e.g., when the flange 147a is inserted into the channel 153 that is formed between the first lid 114a and the housing 106). In some embodiments, the second inner surface 127 (e.g., the second sealing surface) of the housing 106 includes a cylindrical sidewall having uniform radius along its length in the axial direction (e.g., along an axial segment of the second inner surface 127 that is longer than an axial height of the channel 153 when the first lid 114a is fully installed onto the housing 106). Such an arrangement can help maintain sealing between the first seal member 170 and the second inner surface 127 of the housing 106 during operation regardless of the position of the flange 147a within the channel 153.

In embodiments that include the standpipe 113, as in FIG. 12, the interface between the filter housing assembly 102 and the first endplate 134a is configured so that the second seal member 172 is sealingly engaged with the filter housing assembly 102 (e.g., the housing 106) when (i) the flange 147a is engaged with the first lid 114a, and (ii) the first lid 114a is fully installed onto the housing 106. In some embodiments, the standpipe 113 defines a cylindrically shaped outer surface that has an approximately uniform outer diameter along an axial segment of the standpipe 113 that is longer than an axial height of the channel 153 when the first lid 114a is fully installed onto the housing 106. Such an arrangement can help maintain sealing between the second seal member 172 and the standpipe 113 during operation regardless of the position of the flange 147a within the channel 153.

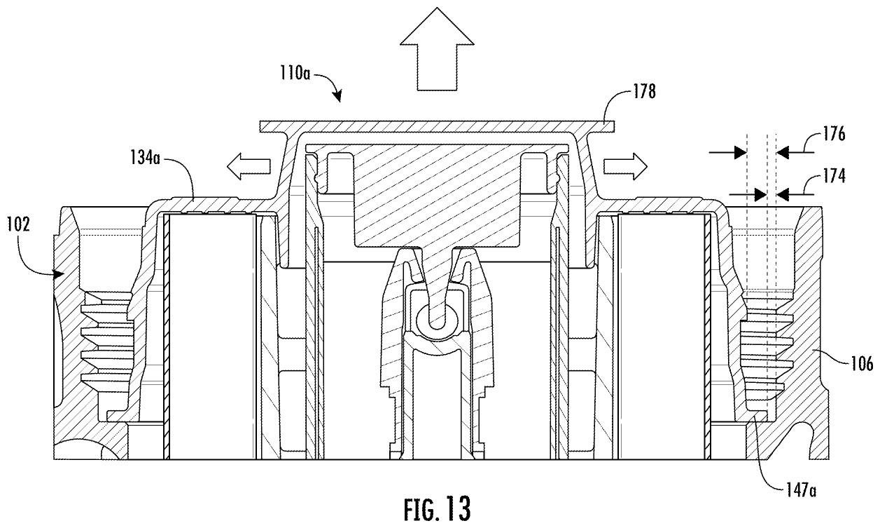

Referring to FIG. 13, the interface between the filter housing assembly 102 and the first endplate 134a is also configured to (i) reduce radial clearance between the first endplate 134a and the filter housing assembly 102 (e.g., the housing 106 and the first lid 114a) when the first lid 114a is installed onto the housing 106, and (ii) increase radial clearance between the first endplate 134a and the filter housing assembly 102 (e.g., the housing 106 and the first lid 114a) when the first lid 114a is removed from the housing 106, which can facilitate servicing of the first stage filter cartridge 110a. In at least one embodiment, the filter housing assembly 102 and the first endplate 134a are shaped so that a first radial clearance 174 between the flange 147a and the housing 106 when the first lid 114a is removed from the housing 106 is within a range between 3.1 mm to 4.3 mm, such as approximately 3.7 mm, and a second radial clearance 176 between the protrusion 150 and the housing 106 is within a range between 4.91 and 5.41 mm, such as approximately 5.16 mm. In other embodiments, the radial clearances between the first endplate 134a and the filter housing assembly 102 (when the first lid 114a is removed from the housing 106) are different. After installing the first lid 114a, the second radial clearance 176 between the protrusion 150 and the filter housing assembly 102 is reduced (e.g., to within a range between 0.25 mm to 0.85 mm, etc.). For example, the second radial clearance 176 is reduced by a factor of 6, 8, 10, or greater in various embodiments. Such clearance between the first endplate 134a and the housing 106 allow a service technician to rock the first stage filter cartridge 110a back and forth to help disengage the seal member(s) from the housing 106. In other embodiments, the first radial clearance 174 and/or the second radial clearance 176 may be different. In one embodiment, the first lid 114a inserts over the flange 147a and also reduces the radial clearance (e.g., the first radial clearance 174) between the flange 147a and the filter housing assembly 102 when the first lid 114a is installed onto the housing 106. In some embodiments, the first endplate 134a also includes a handle 178 to facilitate user interaction with the first stage filter cartridge 110a during removal.

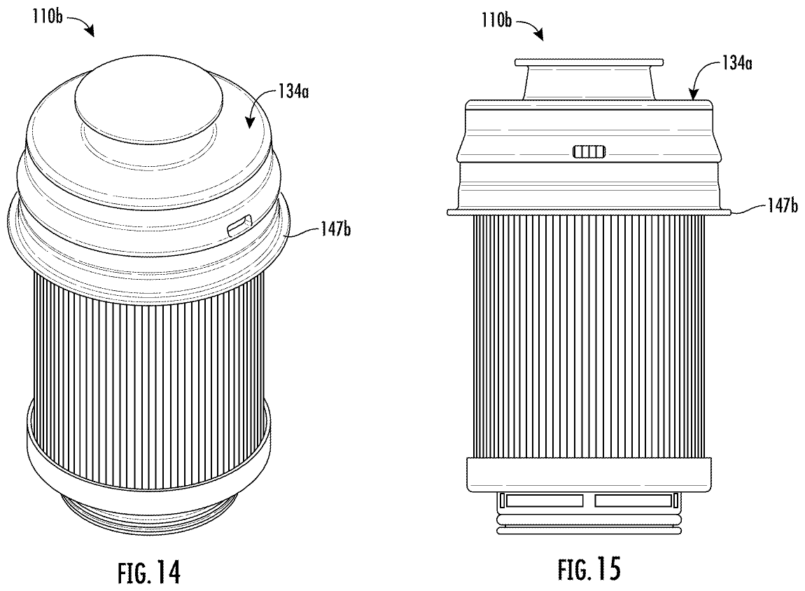

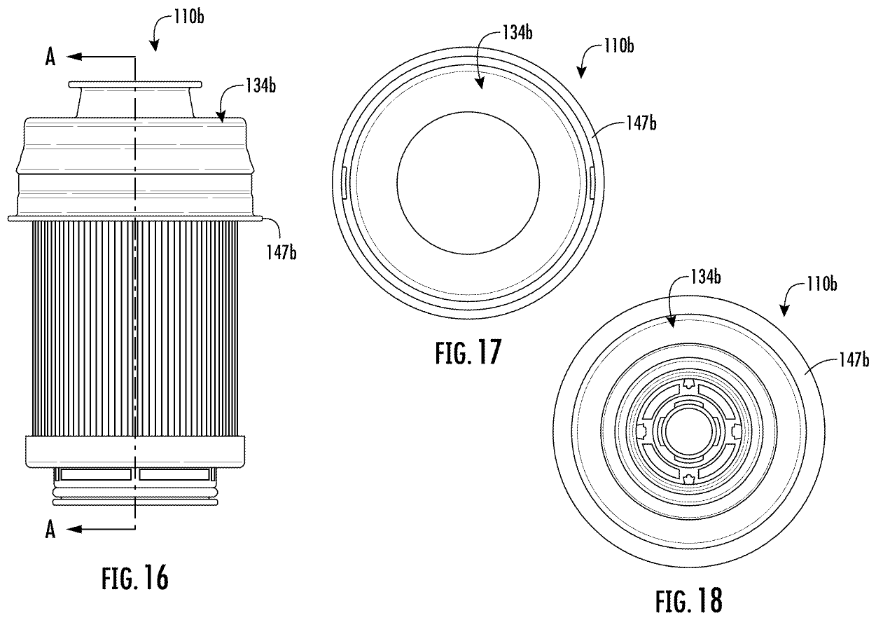

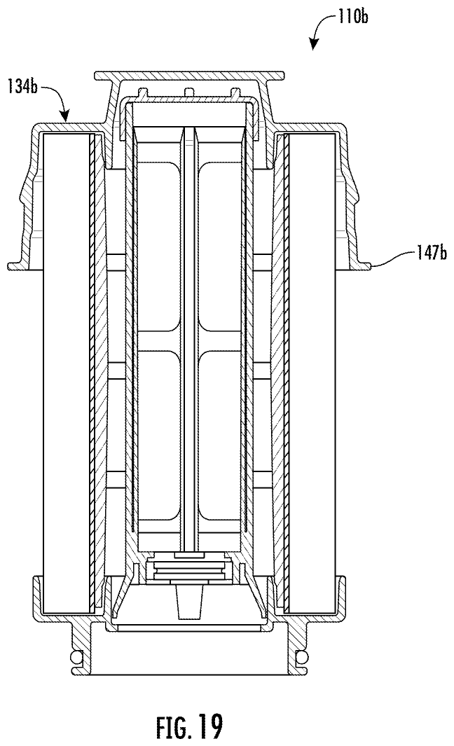

Referring to FIGS. 14-19, the second stage filter cartridge 110b for the filter assembly 101 is shown, according to an embodiment. In at least one embodiment, the design of the second stage filter cartridge 110b is the same as or similar to the first stage filter cartridge 110a. In other embodiments, the design of the second stage filter cartridge 110b is different from the first stage filter cartridge 110a. In the embodiment of FIGS. 14-19, the second stage filter cartridge 110b also includes a first endplate 134b having a radially extending flange 147b that interfaces with the second lid 114b and the housing 106 to facilitate installation of the second stage filter cartridge 110b into the housing 106 and to ensure that the second stage filter cartridge 110b remains sealingly engaged to the housing 106 during operation.

### II. Example Method of Installing a Filter Cartridge into a Filter Assembly

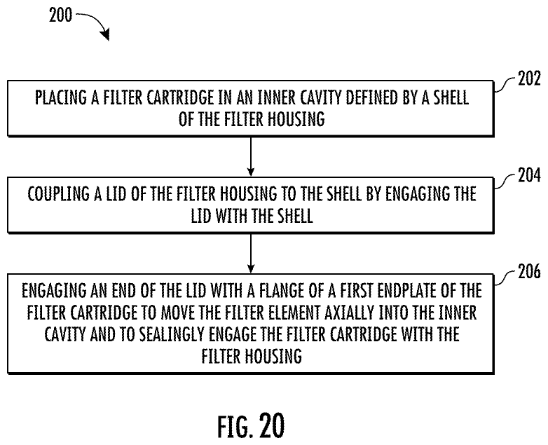

Referring to FIG. 20, a method 200 of installing a filter cartridge, such as the first stage filter cartridge 110a and/or the second stage filter cartridge 110b, into a filter housing assembly (e.g., the filter housing assembly 102 of FIGS. 1-4) is shown, according to an embodiment. At operation 202, a filter cartridge is inserted into an inner cavity defined by a housing of the filter housing assembly. In at least one embodiment, operation 202 includes aligning the filter cartridge with an opening of the inner cavity and inserting the filter cartridge through the opening.

At operation 204, a lid of the filter housing assembly is coupled to the housing of the filter housing assembly by engaging the lid with the housing. In at least one embodiment, operation 204 includes threadably engaging the lid with the housing and rotating the lid with respect to the housing. At operation 206, the lid is rotated or otherwise moved relative to the housing to engage an end of the lid with a flange of a first endplate of the filter cartridge to move the filter cartridge axially into the inner cavity and to sealingly engage the filter cartridge with the housing. In some embodiments, operation 206 includes engaging an axially facing surface at a distal end of the lid with an axially facing surface of the flange of the first endplate that extends radially away from the first endplate. In some embodiments, operation 206 includes sealingly engaging a first seal member with the housing, and sealingly engaging a second seal member with a standpipe of the filter housing assembly. In some embodiments, operation 206 includes rotating the lid until a stop member of the lid engages the housing to form a channel between the distal end of the lid and an internal ledge of the housing.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter assembly, comprising:
a filter housing assembly, including:
a housing defining an inner cavity; and
a lid engageable with the housing at an opening of the inner cavity, an end of the lid spaced apart from the housing to form a channel therebetween when the lid is fully installed onto the housing; and
a filter element disposed within the inner cavity, the filter element including:
a media pack having a media pack first end and a media pack second end opposite the media pack first end;
a first endplate sealingly engaged with the media pack first end, the first endplate including a flange extending radially away from the media pack, the flange extending into the channel between the lid and the housing;
a second endplate coupled to the media pack second end; and
a first seal member coupled to the second endplate, the first seal member sealingly engaged with the housing when (i) the flange is engaged with the lid and (ii) the lid is fully installed onto the housing.

2. The filter assembly of claim 1, further comprising a standpipe coupled to the housing and extending into the inner cavity, the filter element further including a second seal member, the second seal member sealingly engaged with the standpipe when (i) the flange is engaged with the lid and (ii) the lid is fully installed onto the housing.

3. The filter assembly of claim 1, wherein the housing includes a threaded portion along a first inner surface of the housing, and a ledge extending radially inward from the first inner surface, the lid and the ledge together defining the channel, wherein an outer diameter of the ledge is greater than an outer diameter of the lid at the end of the lid.

4. The filter assembly of claim 1, wherein the flange is spaced axially apart from at least one of the lid or the housing to form an axial gap between (i) the flange and (ii) the at least one of the lid or the housing when the lid is fully installed onto the housing.

5. The filter assembly of claim 1, wherein the first endplate further comprises a skirt extending along a longitudinal axis of the media pack from the media pack first end toward the media pack second end, the flange extending radially away from the skirt proximate to a distal end of the skirt.

6. The filter assembly of claim 1, wherein the first endplate further includes a protrusion extending radially away from the media pack, the protrusion disposed axially between the flange and the media pack first end, wherein an outer diameter of the protrusion is less than an outer diameter of the flange.

7. The filter assembly of claim 6, wherein an inner diameter of the first endplate at the protrusion is less than an inner diameter of the first endplate at the flange.

8. The filter assembly of claim 6, wherein an outer diameter of the first endplate in a region of the first endplate between the protrusion and the flange increases from the protrusion to the flange.

9. The filter assembly of claim 6, wherein the lid defines a groove extending in a circumferential direction along an inner surface of the lid, the protrusion engaged with the groove.

10. The filter assembly of claim 1, wherein the housing defines a ledge extending radially inward from an inner surface of the housing, the lid and the ledge together defining the channel, wherein an outer diameter of the ledge is greater than an outer diameter of the flange.

11. A filter element, comprising:
a media pack having a media pack first end and a media pack second end opposite the media pack first end;
a first endplate sealingly engaged with the media pack first end, the first endplate including:
a skirt extending along a longitudinal axis of the media pack from the media pack first end toward the media pack second end;
a flange extending radially away from the skirt proximate to a distal end of the skirt; and
a protrusion extending radially away from the skirt, the protrusion disposed axially between the flange and a proximal end of the skirt, at least one of an inner diameter of the skirt or an outer diameter of the skirt in a first region of the skirt between the protrusion and the flange increases from the protrusion to the flange.

12. The filter element of claim 11, wherein the inner diameter of the skirt in a second region of the skirt between the protrusion and the proximal end of the skirt increases from the proximal end of the skirt to the protrusion.

13. The filter element of claim 11, wherein the protrusion defines a tapered outer radial surface having an increasing outer diameter moving from a proximal end of the skirt toward a distal end of the skirt.

14. The filter element of claim 11, wherein the first endplate further defines at least one vent opening extending radially through the protrusion.

15. The filter element of claim 11, wherein the protrusion includes a continuous ring extending in a circumferential direction around the skirt relative to a central axis of the media pack.

16. The filter element of claim 11, wherein a radial length of the flange that extends between the outer diameter of the skirt and an outer diameter of the flange is greater than at least two times a radial length of the protrusion that extends between the outer diameter of the skirt and an outer diameter of the protrusion.

17. The filter element of claim 11, further comprising:
a second endplate coupled to the media pack second end; and
a seal member coupled to the second endplate, the seal member facing radially away from the second endplate.

18. The filter element of claim 11, further comprising:
a hydrophobic screen assembly disposed within a central cavity defined by the media pack; and
a second seal member coupled to the hydrophobic screen assembly and facing radially away from the hydrophobic screen assembly.

19. A method of installing a filter element into a filter housing assembly, comprising:
placing the filter element in an inner cavity defined by a housing of the filter housing assembly;
coupling a lid of the filter housing assembly to the housing by engaging the lid with the housing; and
engaging an end of the lid with a flange of a first endplate of the filter element to move the filter element axially into the inner cavity and to sealingly engage the filter element with the housing.

20. The method of claim 19, wherein engaging the lid with the flange to sealingly engage the filter element with the housing includes sealingly engaging a first seal member with the housing; and sealingly engaging a second seal member with a standpipe of the filter housing assembly.

21. The method of claim 19, wherein coupling the lid to the housing includes threadably engaging the lid to the housing and rotating the lid until a stop member of the lid engages the housing.
